(19) United States
(12) Patent Application Publication
(10) Pub. No.: US 2007/0146555 A1
(43) Pub. Date: Jun. 28, 2007

(54) Tuner unit, information processing apparatus including tuner unit, and method for detecting receive channel

(76) Inventor: Naoyuki Wada, Tokyo (JP)

Correspondence Address: KNOBBE MARTENS OLSON & BEAR LLP, 2040 MAIN STREET, FOURTEENTH FLOOR, IRVINE, CA, 92614, US

(21) Appl. No.: 11/642,108

(22) Filed: Dec. 20, 2006

(30) Foreign Application Priority Data
Dec. 26, 2005 (JP) 2005-372950

(51) Int. Cl. H04N 5/50

(52) U.S. Cl. 348/732

(57) ABSTRACT

A tuner unit includes a scan-candidate registration unit that registers candidate frequencies to be scanned, a scan-frequency selection unit that selects frequencies to be scanned, a first scan unit that performs scanning on the basis of the frequencies to be scanned, a reception determination unit that determines whether channel signals can be received, a scan-candidate-frequency update unit that registers, as detected frequencies, frequencies of ones of the channel signals that can be received and eliminates ones of the candidate frequencies to be scanned within a predetermined range with its center at each of the detected frequencies, and a second scan unit that performs scanning on the basis of the updated candidate frequencies to be scanned. Even when the second scan unit performs scanning, the scan-candidate-frequency update unit performs the same process as described above.

### CROSS-REFERENCE TO RELATED APPLICATIONS

This application claims the benefit of priority of Japanese Patent Application No. 2005-372950, filed Dec. 26, 2005, the entire contents of which are incorporated herein by reference.

### BACKGROUND

1. Field

The present invention relates to tuner units, information processing apparatuses that include the tuner units, and methods for detecting receive channels, and in particular, relates to a tuner unit that scans a frequency band for TV channels to detect receive channels, an information processing apparatus that includes the tuner unit, and a method for detecting receive channels.

2. Description of the Related Art

Currently, in many cases, a single TV receiver can receive, in addition to known analog terrestrial broadcasts, broadcasts via various types of broadcast medium, for example, digital terrestrial broadcasts or satellite TV broadcasts. Thus, recently, the number of channels that can be received by a single TV receiver has significantly increased. Accordingly, the number of frequencies for TV broadcasts transmitted from various types of broadcast medium has significantly increased.

However, although TV receivers have the capability to receive a very broad range of TV channels, the TV frequencies that can be received by TV receivers vary with areas where the TV receivers are actually located.

That is to say, since predetermined frequencies for TV broadcasting are assigned to countries or areas, the frequencies of TV channels that can be received vary with countries or areas.

Thus, TV receivers have come into wide use, in which the frequencies of TV channels, out of many receive channels, that can be received in a country or an area where the TV receivers are located are registered in, for example, a frequency table in advance so that a desired TV channel can be readily selected with reference to the table.

Moreover, many TV receivers have the following function: When users buy the brand-new TV receivers or when the TV receivers are moved from one country or area to another country or area, a broad frequency range is scanned to detect TV frequencies that can be received in a country or an area where the TV receivers are actually used and register the detected TV frequencies in a frequency table. Hereinafter, such a function is called an automatic frequency registration function.

When the automatic frequency registration function is implemented, it is required to scan a broad frequency range and examine detection of TV signals at individual scanned frequencies. Thus, a considerable processing time is required.

Accordingly, various types of technique are proposed for reducing the time necessary to perform the automatic frequency registration.

For example, a technique is disclosed in JP-A 2005-64585 for reducing the time necessary to search for digital TV broadcast channels. This technique is intended for use by a receiver that can receive analog TV broadcasts and digital TV broadcasts to reduce the time necessary to search for digital TV broadcast frequencies (channels) by executing the following steps: The frequencies (the channels) for analog TV broadcasting that can be received are first detected. Then, digital TV broadcast frequencies are searched for after eliminating frequencies at which analog TV broadcasts can be received from frequencies subjected to the search.

Another technique is disclosed in US 2003/0073459 A1 for reducing the time necessary to search for channels for, for example, satellite TV broadcasting. In satellite TV broadcasting, a plurality of channels that have different band widths exist. In known techniques, scanning is performed with a frequency spacing corresponding to the smallest channel width. On the other hand, in this technique, scanning is performed with frequency spacings corresponding to individual channel widths to reduce the total time necessary to search for channels.

Yet another technique is disclosed in US 2002/0097344 A1 for reducing the time necessary to search for channels for digital TV broadcasting. When a channel for digital TV broadcasting that can be received is determined, lock-status examination is performed to obtain the channel information. It takes much time to perform lock-status examination. In view of this problem, an object of this technique is to reduce the total time necessary to search for channels by reducing the number of times lock-status examination is performed by executing the following steps: Preliminary scan processing is first performed only to check the intensities of received signals. Then, normal scan processing is performed only on channels in which the intensities of received signals are more than a predetermined threshold value. In the normal scan processing, lock-status is examined.

Recently, information processing apparatuses, for example, personal computers, that include TV tuner units have come into wide use. The area where many of such information processing apparatuses can be used is not limited to a specific country or area. That is to say, many of such information processing apparatuses are designed so that they can be used all over the world.

Thus, unlike known TV receivers that support only a reception system, a receive frequency range, and the like specific to a country or an area where they are used, TV tuner units included in information processing apparatuses and the like have a function of receiving broadcasts in all countries or areas.

When TV tuner units included in information processing apparatuses are designed so that they can be used all over the world, the development cost, the design cost, the maintenance cost, the repairing cost, and the like can be totally reduced.

However, when TV tuner units support all countries or areas, the TV tuner units need to cover a broad frequency range. Moreover, transmit frequencies assigned to TV channels vary with countries or areas.

In Japan, the band width for TV broadcasting is fixed to 6 MHz, the spacing between transmit frequencies is basically 6 MHz, and transmit frequencies assigned to TV channels are predetermined. Thus, when only the specifications required in Japan need to be satisfied, the automatic frequency registration, in which frequencies are scanned, can be performed in a relatively short time.

However, for example, in Europe, a certain country and a neighboring country may have different band widths (or frequency spacings), different transmit frequencies, or the like. Thus, when residents in a certain country need to watch TV broadcasts in a neighboring country, a broad frequency range needs to be scanned in many steps in the automatic frequency registration.

It is probable that residents in a certain country can readily obtain a correspondence table of TV channels in the certain country and frequencies. However, it may be difficult for the residents to obtain a correspondence table of TV channels in a neighboring country and frequencies.

Thus, in known VHF/UHF TV tuner units for worldwide use, for example, frequency scanning is performed in a range of 44 MHz to 860 MHz using a step spacing of 1 MHz in the automatic frequency registration.

Moreover, the band width is not limited to 6 MHz applicable to Japan and is 7 MHz or 8 MHz in some countries. Thus, the band of a receive filter may need to be changed so as to adapt to individual cases when determination of whether a broadcast can be received is made. Accordingly, the time necessary to perform the automatic frequency registration may further increase.

The techniques disclosed in JP-A 2005-64585, US 2003/0073459 A1, and US 2002/0097344 A1 are provided to reduce the time necessary to perform the automatic frequency registration. However, when these techniques are applied to the foregoing TV tuner units for worldwide use, the effect is unsatisfactory. Thus, another technique for reducing the time necessary to perform the automatic frequency registration is desired.

### SUMMARY OF THE INVENTION

In view of the foregoing problems, it is an object of the present invention to provide a tuner unit, an information processing apparatus including the tuner unit, and a method for detecting receive channels in which, even when a broad frequency range needs to be scanned in many steps because information of transmit frequencies is not available, the automatic frequency registration can be efficiently performed in a short time.

To solve the foregoing problems, a tuner unit according to an aspect of the present invention is provided, which scans a predetermined frequency range, detects channel signals that can be received, and registers frequencies of the channel signals. The tuner unit includes a scan-candidate registration unit that registers frequencies in the predetermined frequency range at predetermined minimum detection spacings as candidate frequencies to be scanned, a scan-frequency selection unit that selects frequencies to be scanned from the candidate frequencies to be scanned at spacings each of which is substantially the same as a band width of the channel signals, a first scan unit that scans the predetermined frequency range on the basis of the frequencies to be scanned, a reception determination unit that determines whether channel signals that are scanned on the basis of the frequencies to be scanned can be received, a scan-candidate-frequency update unit that registers, as detected frequencies, frequencies of ones of the channel signals that are determined by the reception determination unit as being capable of being received and eliminates ones of the candidate frequencies to be scanned within a predetermined range with its center at each of the detected frequencies to update the candidate frequencies to be scanned, and a second scan unit that performs scanning on the basis of the updated candidate frequencies to be scanned after the first scan unit scans the predetermined frequency range. Even when the second scan unit performs scanning, the scan-candidate-frequency update unit registers, as detected frequencies, frequencies of ones of the channel signals that are determined by the reception determination unit as being capable of being received and eliminates ones of the candidate frequencies to be scanned within a predetermined range with its center at each of the detected frequencies to update the candidate frequencies to be scanned.

An information processing apparatus according to another aspect of the present invention includes an information-processing-apparatus body that performs various types of information processing, a tuner unit that scans a predetermined frequency range, detects channel signals that can be received, and registers frequencies of the channel signals, and a display that displays various types of information and images received by the tuner unit. The tuner unit includes a scan-candidate registration unit that registers frequencies in the predetermined frequency range at predetermined minimum detection spacings as candidate frequencies to be scanned, a scan-frequency selection unit that selects frequencies to be scanned from the candidate frequencies to be scanned at spacings each of which is substantially the same as a band width of the channel signals, a first scan unit that scans the predetermined frequency range on the basis of the frequencies to be scanned, a reception determination unit that determines whether channel signals that are scanned on the basis of the frequencies to be scanned can be received, a scan-candidate-frequency update unit that registers, as detected frequencies, frequencies of ones of the channel signals that are determined by the reception determination unit as being capable of being received and eliminates ones of the candidate frequencies to be scanned within a predetermined range with its center at each of the detected frequencies to update the candidate frequencies to be scanned, and a second scan unit that performs scanning on the basis of the updated candidate frequencies to be scanned after the first scan unit scans the predetermined frequency range. Even when the second scan unit performs scanning, the scan-candidate-frequency update unit registers, as detected frequencies, frequencies of ones of the channel signals that are determined by the reception determination unit as being capable of being received and eliminates ones of the candidate frequencies to be scanned within a predetermined range with its center at each of the detected frequencies to update the candidate frequencies to be scanned.

A receive-channel detecting method according to yet another aspect of the present invention is provided for scanning a predetermined frequency range, detecting channel signals that can be received, and registering frequencies of the channel signals. The method includes a scan-candidate registration step of registering frequencies in the predetermined frequency range at predetermined minimum detection spacings as candidate frequencies to be scanned, a scan-frequency selection step of selecting frequencies to be scanned from the candidate frequencies to be scanned at spacings each of which is substantially the same as a band width of the channel signals, a first scan step of scanning the predetermined frequency range on the basis of the frequencies to be scanned, a reception determination step of determining whether channel signals that are scanned on the basis of the frequencies to be scanned can be received, a scan-candidate-frequency update step of registering, as detected frequencies, frequencies of ones of the channel signals that are determined as being capable of being received and eliminating ones of the candidate frequencies to be scanned within a predetermined range with its center at each of the detected frequencies to update the candidate frequencies to be scanned, and a second scan step of performing scanning on the basis of the updated candidate frequencies to be scanned after the first scan step scans the predetermined frequency range. Even when the second scan step performs scanning, the scan-candidate-frequency update step registers, as detected frequencies, frequencies of ones of the channel signals that are determined as being capable of being received and eliminates ones of the candidate frequencies to be scanned within a predetermined range with its center at each of the detected frequencies to update the candidate frequencies to be scanned.

In the tuner unit, the information processing apparatus including the tuner unit, and the method for detecting receive channels according to the aspects of the present invention, even when a broad frequency range needs to be scanned in many steps because information of transmit frequencies is not available, the automatic frequency registration can be efficiently performed in a short time.

### BRIEF DESCRIPTION OF THE DRAWINGS

The accompanying drawings, which are incorporated in and constitute a part of the specification, illustrate embodiments of the invention, and together with the general description given above and the detailed description of the embodiments given below, serve to explain the principles of the invention.

FIG. 1 is a perspective view of an information processing apparatus according to an embodiment of the present invention;

FIG. 2 is a block diagram showing an exemplary system configuration of the information processing apparatus according to the embodiment;

FIG. 3 is a block diagram showing an exemplary configuration of a TV tuner unit according to the embodiment;

FIG. 4 is a functional block diagram of the TV tuner unit according to the embodiment;

FIG. 5 is a flowchart showing the flow of the overall process of a method according to the embodiment for detecting receive channels;

FIG. 6 is a flowchart showing the detailed process of creating a scan frequency table;

FIG. 7 is a flowchart showing the detailed flow of a first scanning process;

FIG. 8 is a schematic view showing a process of deleting candidate frequencies to be scanned;

FIG. 9 is a flowchart showing the detailed flow of a second scanning process;

FIG. 10 shows an example of the scan frequency table;

FIG. 11 shows a status of the scan frequency table;

FIG. 12 shows another status of the scan frequency table;

FIG. 13 shows yet another status of the scan frequency table;

FIG. 14 shows yet another status of the scan frequency table;

FIG. 15 shows yet another status of the scan frequency table;

FIG. 16 shows yet another status of the scan frequency table;

FIG. 17 shows yet another status of the scan frequency table; and

FIG. 18 shows yet another status of the scan frequency table.

### DETAILED DESCRIPTION

A tuner unit, an information processing apparatus that includes the tuner unit, and a method for detecting receive channels according an embodiment of the present invention will now be described with reference to the attached drawings.

(1) Configuration of Information Processing Apparatus

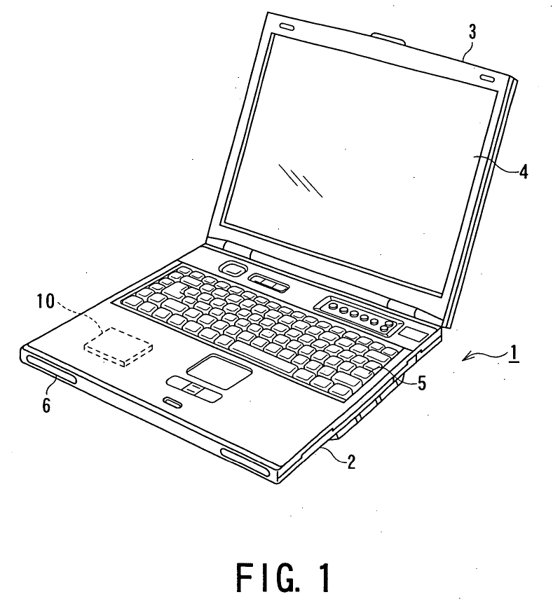

FIG. 1 is an external view of an information processing apparatus 1 according to the embodiment of the present invention. The information processing apparatus 1 is a notebook personal computer.

The information processing apparatus 1 includes an information-processing-apparatus body 2 and a panel unit 3 that are thin and have a rectangular shape. The panel unit 3 is attached to the information-processing-apparatus body 2 with hinges. The panel unit 3 can be freely opened and closed.

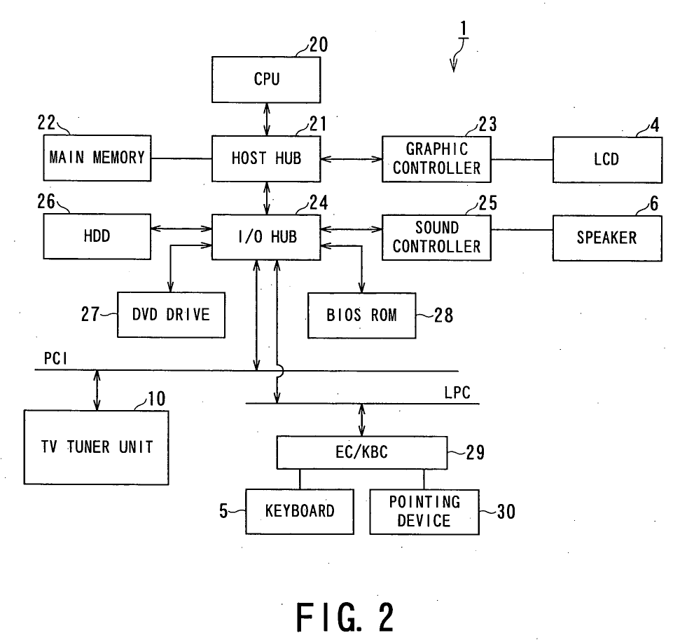

A keyboard 5 and the like are provided on the upper surface of a casing of the information-processing-apparatus body 2. The keyboard 5 and the like are used to input various types of data and perform various types of operation of the information processing apparatus 1. The information-processing-apparatus body 2 further includes a system board that includes electronic components, for example, a CPU 20, a chip set, and a main memory 22 (FIG. 2), a TV tuner unit 10 that receives TV broadcasts, and the like.

A display 4 for displaying various types of information is provided in an aperture on a surface, opposing the information-processing-apparatus body 2, of the panel unit 3. The display 4 includes, for example, a liquid crystal display. The display 4 displays various types of information to be processed in the information-processing-apparatus body 2, images from TV broadcasts received by the TV tuner unit 10, and the like. A speaker 6 outputs, for example, voices from TV broadcasts received by the TV tuner unit 10.

FIG. 2 is a block diagram showing an exemplary system configuration of the information processing apparatus 1. The information processing apparatus 1 includes the CPU 20, which performs overall control of the system. The CPU 20 exchanges data with various types of inner component in the information processing apparatus 1 via the chip set, which includes a host hub 21 and an I/O hub 24.

The inner components provided in the information processing apparatus 1 include the main memory 22, which functions as a work area of the CPU 20 to temporarily store programs, data, and the like, a BIOS ROM 28 that stores BIOS, a graphic controller 23 that processes various types of image data to be displayed on the display 4, a sound controller 25 that processes audio signals and outputs the processed audio signals to the speaker 6, an HDD 26 and a DVD drive 27 that function as storage units, and the like.

The keyboard 5, a pointing device 30, and the like are provided as user interfaces and connected to the I/O hub 24 via a controller (EC/KBC) 29.

The information processing apparatus 1 further includes the TV tuner unit 10 as one of the inner components. The TV tuner unit 10 is connected to the I/O hub 24 via, for example, a PCI bus. TV broadcast signals in the VHF and UHF bands are input from an antenna terminal (not shown) to the TV tuner unit 10. The signals demodulated by the TV-tuner unit 10 are sent to the graphic controller 23 and the sound controller 25 via the I/O hub 24 and the host hub 21 and output to the display 4 and the speaker 6 as video signals and audio signals. In FIG. 2, the TV tuner unit 10 is connected to the I/O hub 24 via a PCI bus. Alternatively, the TV tuner unit 10 may be connected to the I/O hub 24 via another type of bus, for example, a USB or an IEEE 1394 bus.

FIG. 2 shows just an exemplary system configuration of the information processing apparatus 1, and the system configuration is not limited to that shown in FIG. 2.

(2) Configuration of TV Tuner Unit

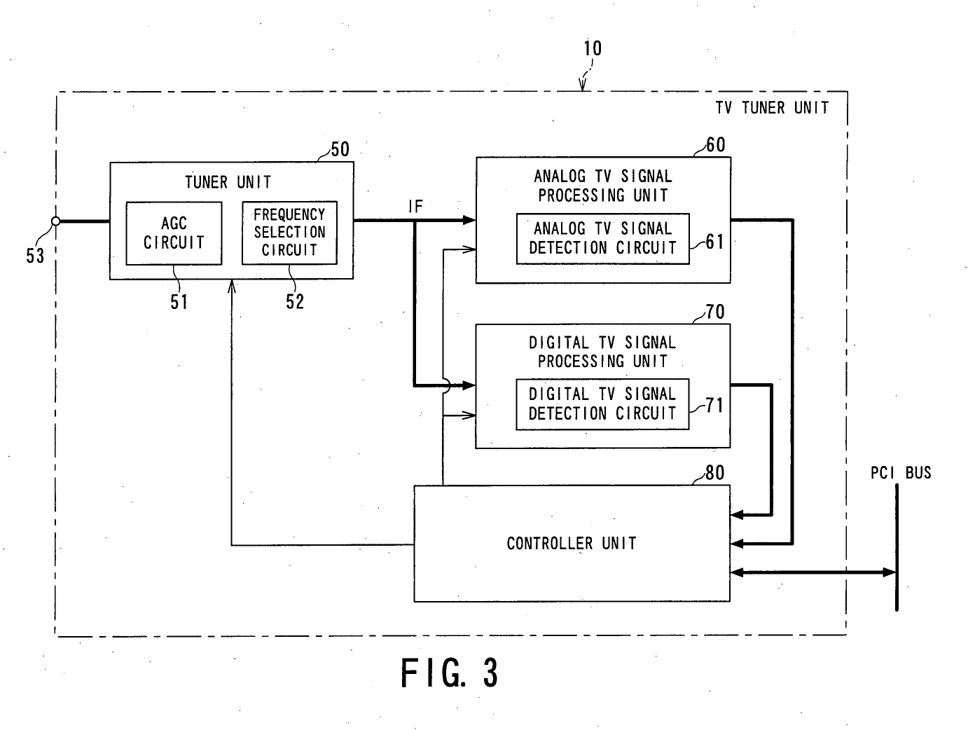

FIG. 3 is a block diagram showing an exemplary configuration of the TV tuner unit 10 according to the embodiment of the present invention.

The TV tuner unit 10 includes a tuner unit 50, an analog TV signal processing unit 60, a digital TV signal processing unit 70, and a controller unit 80.

TV broadcast signals in the VHF band and the UHF band are input from a tuner input terminal 53 to the tuner unit 50 and converted to predetermined IF signals to be output to the analog TV signal processing unit 60 and the digital TV signal processing unit 70.

When terrestrial TV broadcasts are received, an antenna (not shown) is connected to the tuner input terminal 53. When CATV is received, the tuner input terminal 53 is connected to a CATV network (not shown).

The tuner unit 50 includes an AGC circuit 51. The tuner unit 50 keeps levels of signals output from the tuner unit 50 constant by amplifying received TV signals when levels of the received TV signals are low and attenuating the received TV signals when the levels of the received TV signals are high using an automatic gain control function of the AGC circuit 51.

The tuner unit 50 further includes a frequency selection circuit 52. The frequency selection circuit 52 selects a specific frequency from input TV broadcast signals in the VHF band and the UHF band and converts the selected frequency to a predetermined intermediate frequency. The selection of a frequency is performed in response to control signals output from the controller unit 80.

The VHF band and the UHF band supported by the tuner unit 50 are set so as to cover TV broadcast bands in many countries, for example, a range of 44 MHz to 860 MHz.

The analog TV signal processing unit 60 demodulates intermediate frequency signals output from the tuner unit 50 and extracts video signals and audio signals of analog TV broadcasts. Data handled in the information processing apparatus 1 is digital data. Thus, the analog TV signal processing unit 60 converts the format of the video signals and the audio signals to a predetermined format of digital data using, for example, an MPEG encoder and outputs the converted signals to the controller unit 80.

The analog TV signal processing unit 60 includes an analog TV signal detection circuit 61. The analog TV signal detection circuit 61 analyzes input signals to detect whether analog TV signals (channel signals) exist in a received band.

Even in a case where frequencies of analog TV signals input from the tuner unit 50 do not exactly coincide with frequencies expected by the analog TV signal detection circuit 61, when the frequency error falls within an allowable range, TV signals can be detected. In this case, the analog TV signal detection circuit 61 detects the frequency error and outputs the detected frequency error to the controller unit 80. The controller unit 80 adjusts selection frequencies for the TV tuner unit 10 on the basis of the frequency error to improve the accuracy of selection frequencies.

Moreover, the analog TV signal detection circuit 61 detects the intensities of received analog broadcast signals and outputs the detected signal intensities to the controller unit 80. The controller unit 80 performs gain control of the AGC circuit 51 in the tuner unit 50 on the basis of the signal intensities. Gain control values of the AGC circuit 51 correspond to the intensities of the received analog broadcast signals. Thus, the controller unit 80 can obtain the intensities of the received analog broadcast signals on the basis of the gain control values of the AGC circuit 51.

The digital TV signal processing unit 70 demodulates intermediate frequency signals output from the tuner unit 50 using a method corresponding to a predetermined modulation method (for example, the OFDM method or the QAM method), extracts demodulated digital TV data (data that contains video signals and audio signals), and outputs the extracted digital TV data to the controller unit 80.

The digital TV signal processing unit 70 includes a digital TV signal detection circuit 71. The digital TV signal detection circuit 71 detects whether digital TV signals (channel signals) exist in a received band. The detection is performed by, for example, determination of whether signals exist or determination of whether signals can be demodulated using a predetermined demodulation method of digital TV broadcasts. When signals can be demodulated, error detection and error correction are performed. Then, detection of digital TV signals is performed by determining whether the corrected data is expected digital TV broadcast data.

Moreover, as in the case of analog TV, the digital TV signal detection circuit 71 detects the intensities of received digital broadcast signals and outputs the detected signal intensities to the controller unit 80. The controller unit 80 performs gain control of the AGC circuit 51 in the tuner unit 50 on the basis of the signal intensities and obtains the intensities of the digital broadcast signals.

In the case shown in FIG. 2, the analog TV signal processing unit 60 and the digital TV signal processing unit 70 are provided. Alternatively, only one of them may be provided.

The controller unit 80 converts digital data of images and voices input from the analog TV signal processing unit 60 or the digital TV signal processing unit 70 to predetermined bus data, for example, PCI bus data, and outputs the converted data to the PCI bus.

The controller unit 80 outputs various types of control signal to the analog TV signal processing unit 60, the digital TV signal processing unit 70, and the like, and performs, for example, gain control of the AGC circuit 51 in the tuner unit 50 and frequency control of the frequency selection circuit 52.

When a TV broadcast channel is selected, the controller unit 80 performs frequency control with reference to a correspondence table of TV broadcast channels and frequencies. Thus, the channel-frequency correspondence table needs to be created and registered in advance.

The point of the present invention is to efficiently create and register the channel-frequency correspondence table in a short time. The TV tuner unit 10 according to the embodiment is configured so as to efficiently perform the following function in a short time: A broad frequency range supported by the TV tuner unit 10 is scanned to detect TV frequencies that can be received in a country or an area where the TV tuner unit 10 (i.e., the information processing apparatus 1 including the TV tuner unit 10) is actually used and register the detected TV frequencies in the aforementioned channel-frequency correspondence table. Hereinafter, such a function is called an automatic frequency registration function.

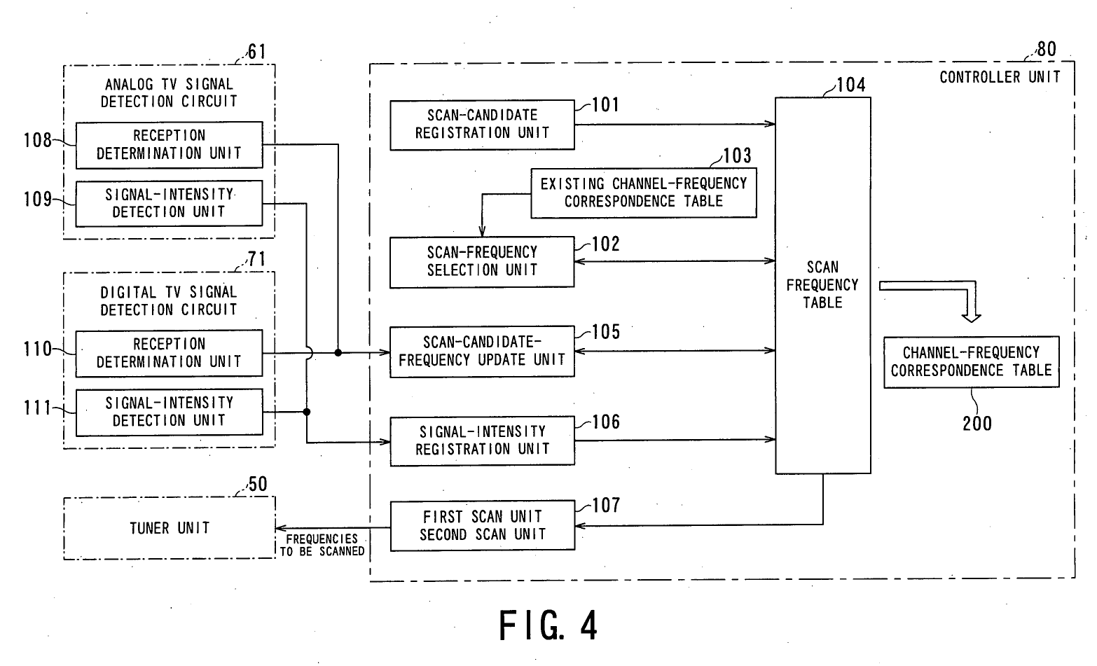

FIG. 4 is a functional block diagram showing functional units related to the aforementioned automatic frequency registration function out of all functional units provided in the controller unit 80.

The controller unit 80 includes a scan-candidate registration unit 101 that registers, as candidate frequencies to be scanned, frequencies each of which is selected from a frequency range to be scanned at the predetermined minimum detection spacings, for example, 1 MHz, and a scan-frequency selection unit 102 that selects frequencies to be scanned from the candidate frequencies to be scanned at spacings each of which is substantially the same as the width of a band of received TV signals (channel signals).

The controller unit 80 further includes a scan frequency table 104. The scan frequency table 104 stores candidate frequencies to be scanned and frequencies to be scanned selected from the candidate frequencies.

On the other hand, the analog TV signal detection circuit 61 and the digital TV signal detection circuit 71 detect whether analog TV signals and digital TV signals have been reliably demodulated, respectively, as described above. These detection functions correspond to reception determination units 108 and 110 in FIG. 4.

Moreover, functions of detecting signal intensities in the analog TV signal detection circuit 61 and the digital TV signal detection circuit 71 correspond to signal-intensity detection units 109 and 111 in FIG. 4.

A signal-intensity registration unit 106 included in the controller unit 80 registers signal intensities output from the signal-intensity detection units 109 and 111 in the scan frequency table 104.

Moreover, a scan-candidate-frequency update unit 105 included in the controller unit 80 updates the scan frequency table 104 on the basis of the result of reception determination performed by the reception determination units 108 and 110. Specifically, the scan-candidate-frequency update unit 105 updates the scan frequency table 104 so that candidate frequencies to be scanned are eliminated from the scan frequency table 104 in steps.

First and second scan units 107 sequentially output frequencies to be scanned to the tuner unit 50 on the basis of the registered or updated scan frequency table 104.

(3) Operation

The operation of the TV tuner unit 10 having the aforementioned configuration will now be described.

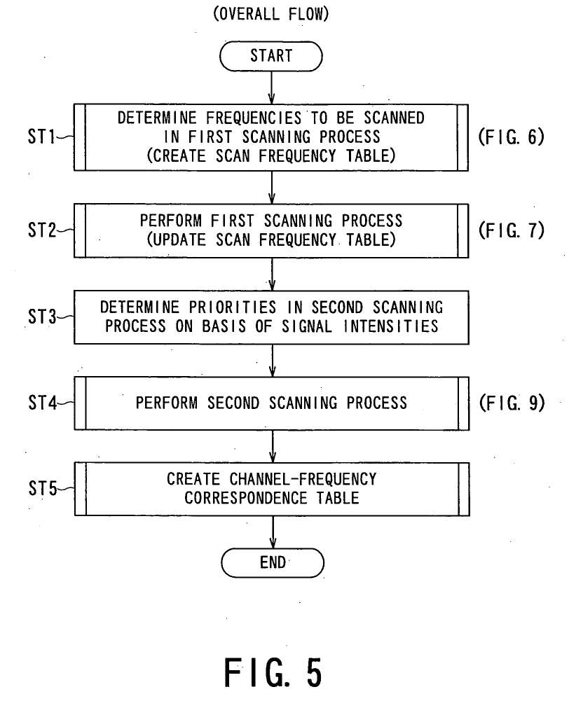

FIG. 5 is a flowchart showing the flow of the overall process of a frequency detecting method (the automatic frequency registration function) performed by the TV tuner unit 10.

In the frequency detecting method according to the embodiment, a first scanning process and a second scanning process are performed, and the frequencies of TV signals detected in these processes are registered in a channel-frequency correspondence table 200 as the frequencies of TV broadcasts that can be received in a corresponding country or area.

In step ST1 in FIG. 5, frequencies to be scanned in the first scanning process are determined, and the scan frequency table 104 is created.

Then, in step ST2, the first scanning process is performed to update the scan frequency table 104.

In step ST3, scanning priorities in the second scanning process are determined on the basis of the intensities of signals obtained in the first scanning process.

In step ST4, the second scanning process is performed according to the determined priorities to update the scan frequency table 104.

Finally, in step ST5, the channel-frequency correspondence table 200 is created from the scan frequency table 104 having been subjected to the second scanning process.

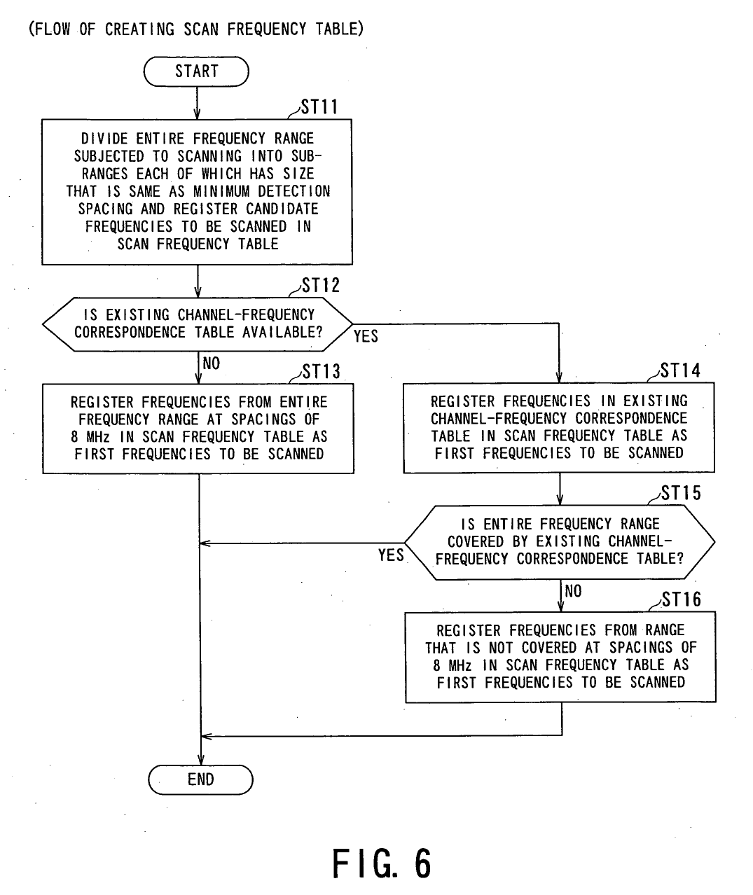

The detailed process in each step will now be described. FIG. 6 is a flowchart showing the detailed process of creating the scan frequency table 104 in step ST1.

In step ST11, the scan frequency table 104 is created, the entire frequency range subjected to scanning is divided into sub-ranges each of which has a size that is the same as the minimum detection spacing, and candidate frequencies to be scanned are registered in the scan frequency table 104.

The entire frequency range subjected to scanning may be a frequency range that covers the VHF bands and the UHF bands for TV broadcasting in all countries, for example, a range of 44 MHz to 860 MHz. The entire frequency range is divided into sub-ranges each of which has a size that is the same as the minimum detection spacing. The minimum detection spacing may be, for example, 1 MHz.

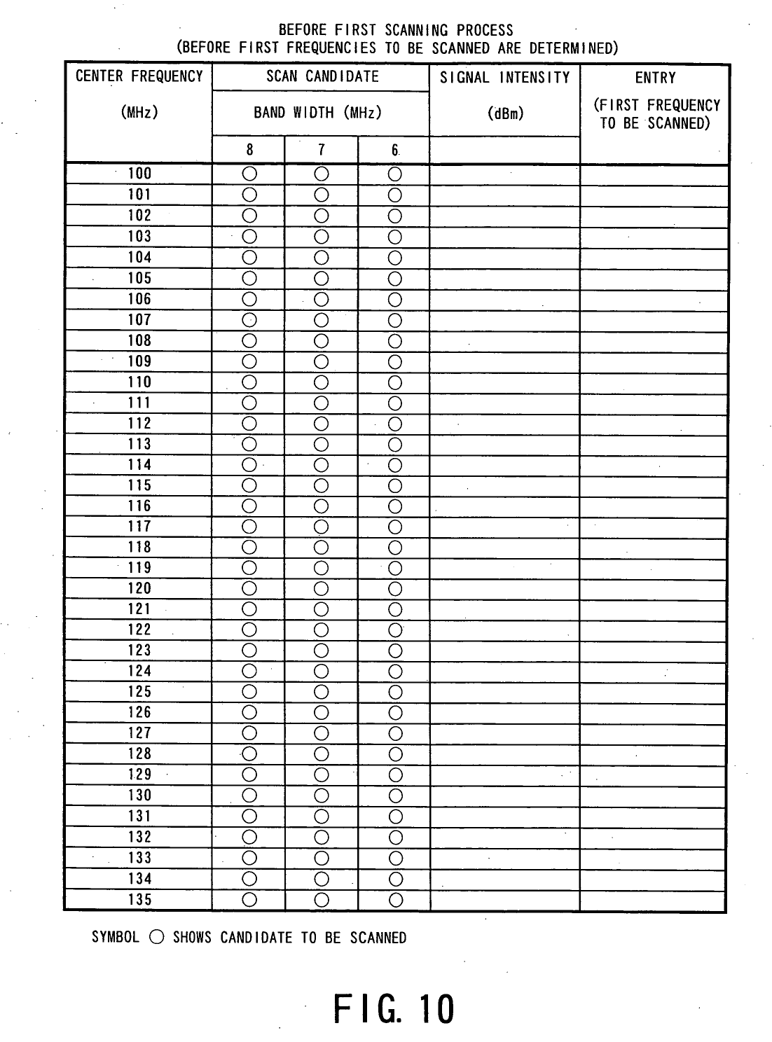

FIG. 10 shows an example of the scan frequency table 104 created in step ST11. FIG. 10 shows only a range of 100 MHz to 135 MHz out of the entire frequency range for the sake of illustration.

Center frequencies shown in the leftmost column of the scan frequency table 104 are selected from a range of 100 MHz to 135 MHz at the minimum detection spacings of 1 MHz.

A column “SCAN CANDIDATE” is divided into three columns “8”, “7”, and “6” each of which indicates a band width (MHz). A symbol ◯ shown in the column “SCAN CANDIDATE” shows that a corresponding center frequency and a corresponding band width are subjected to scanning when the scan frequency table 104 is created.

In Japan, the band width for TV broadcasting is standardized to 6 MHz. However, band widths of 8 MHz, 7 MHz, and 6 MHz exist in the world. Thus, it is required that switching among receive bands having widths of 8 MHz, 7 MHz, and 6 MHz is performed (switching may be performed by, for example, changing the band width of a filter) and determination of whether any TV broadcast can be received at each of the center frequencies is made. In FIG. 10, this is shown by the symbol ◯, which is set in the columns of 8 MHz, 7 MHz, and 6 MHz for each of the center frequencies.

The reason why the spacing (the minimum detection spacing) between the center frequencies is set to a small value, i.e., 1 MHz, is that it is assumed that the center frequencies of TV broadcasts in individual countries are basically unknown. Thus, when candidate frequencies to be scanned are set to determine whether TV broadcasts can be received, the spacing between the center frequencies needs to be small. On the other hand, the allowable error between the actual center frequency of a TV broadcast and a corresponding center frequency set in the tuner unit 50 is said to be about 1 MHz. Accordingly, in this embodiment, the minimum detection spacing is set to 1 MHz.

In known methods for detecting receive channels, determination of whether a TV broadcast can be received is performed for all of the center frequencies for which the symbol ◯ is set in FIG. 10, and ones of the center frequencies at which TV signals are detected are registered in the channel-frequency correspondence table 200. Thus, it takes much time to create and register the channel-frequency correspondence table 200.

On the other hand, in the method for detecting receive channels according to the embodiment, determination of whether a TV broadcast can be received is not performed for all candidate frequencies (shown by the symbol ◯) to be scanned in FIG. 10, but candidate frequencies to be scanned are efficiently narrowed down to reduce the time necessary to create and register the channel-frequency correspondence table 200.

In step ST12 in FIG. 6, it is determined whether an existing channel-frequency correspondence table is available. When a channel-frequency correspondence table in a corresponding country or area can be obtained in advance and when a user desires to watch only broadcasts registered in the channel-frequency correspondence table, it is efficient to use data in the channel-frequency correspondence table.

When it is determined that an existing channel-frequency correspondence table is not available, the process proceeds to step ST13. In step ST13, frequencies are picked up at spacings of 8 MHz from the candidate frequencies to be scanned in the entire frequency range registered in step ST11, and the picked-up frequencies are registered in the scan frequency table 104 as first frequencies to be scanned.

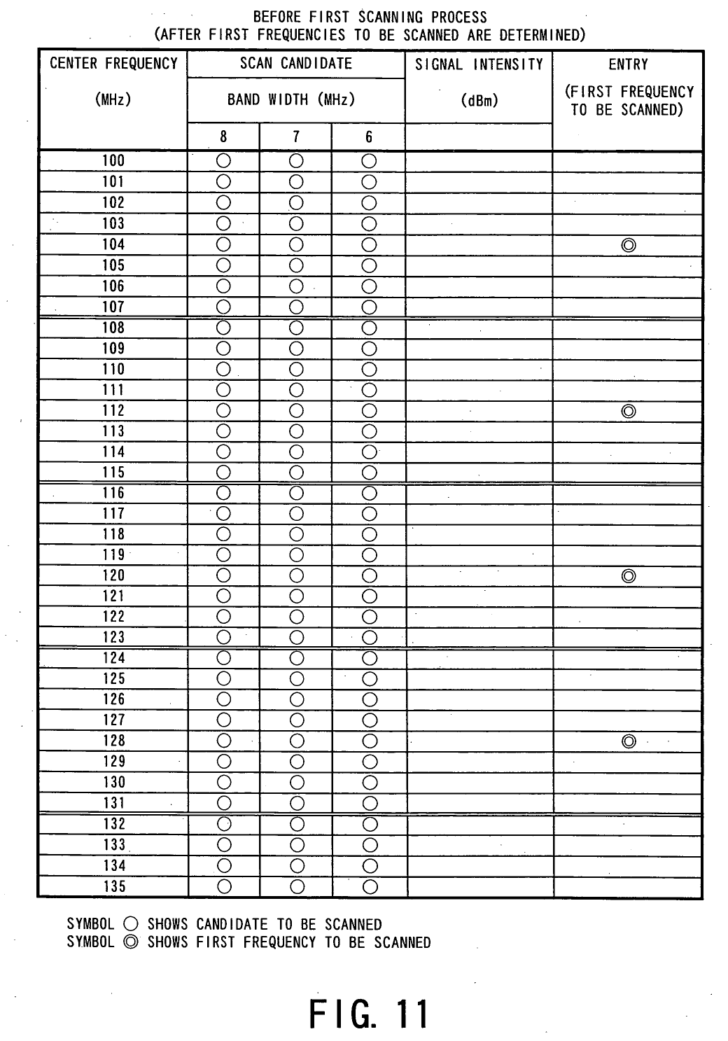

FIG. 11 shows the status of the scan frequency table 104 having been subjected to the process in step ST13. Candidate frequencies to be scanned indicated by a symbol ⊚ set in the rightmost column “ENTRY (FIRST FREQUENCY TO BE SCANNED)” of the scan frequency table 104 shown in FIG. 11 have been entered as the first frequencies to be scanned.

A spacing of 8 MHz with which the first scanning process is performed corresponds to the width of a band of TV signals (channel signals). In the embodiment, the widest band width is selected, as the spacing between frequencies subjected to the first scanning process, from band widths of 8 MHz, 7 MHz, and 6 MHz that vary with countries. Moreover, when the first scanning process is performed with a spacing of 8 MHz, the width of the receive band is also set to 8 MHz.

When it is determined in step ST12 that an existing channel-frequency correspondence table is available, the process proceeds to step ST14. In step ST14, frequencies registered in the existing channel-frequency correspondence table are registered in the scan frequency table 104 as the first frequencies to be scanned.

Then, in step ST15, it is determined whether a frequency range covered by the existing channel-frequency correspondence table covers the entire frequency range. When it is determined that the frequency range covered by the existing channel-frequency correspondence table does not cover the entire frequency range, the process proceeds to step ST16. In step ST16, frequencies are selected at spacings of 8 MHz from a frequency range, out of the entire frequency range, which is not covered by the existing channel-frequency correspondence table, and the selected frequencies are registered in the scan frequency table 104 as the first frequencies to be scanned, as in step ST13.

In this way, the frequencies subjected to the first scanning process are registered in the scan frequency table 104.

FIG. 11 shows the status of registration of the frequencies subjected to the first scanning process in the case where no existing channel-frequency correspondence table is available.

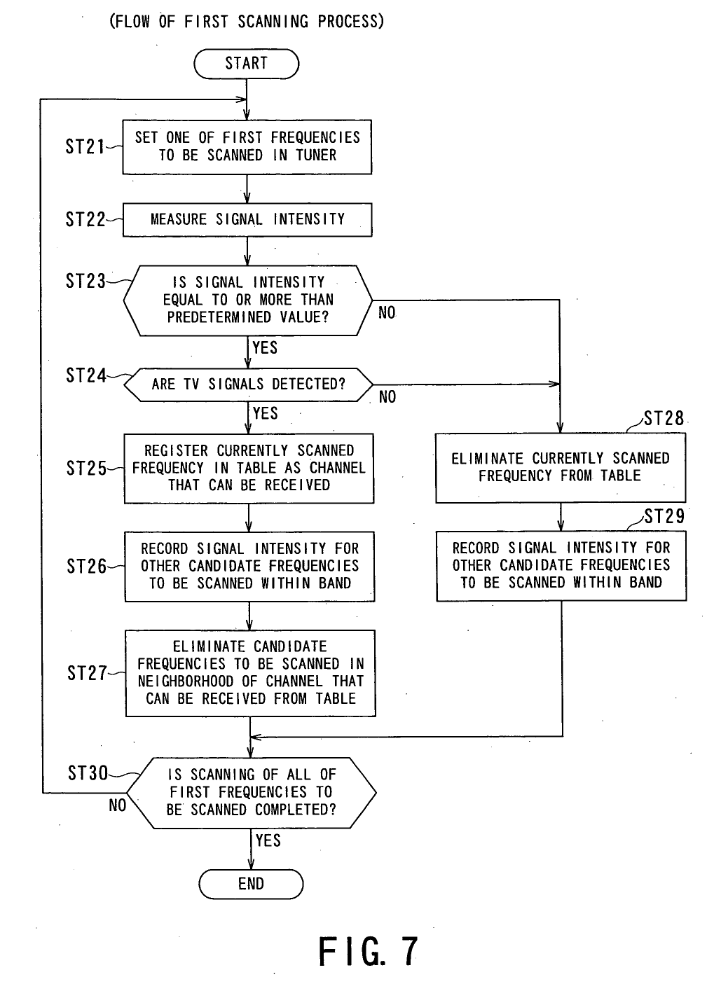

Then, the first scanning process is performed. FIG. 7 is a flowchart showing the detailed flow of the first scanning process.

In step ST21, one of the first frequencies to be scanned is set in the tuner unit 50. The frequency selection circuit 52 in the tuner unit 50 selects a frequency corresponding to the one of the first frequencies to be scanned sent from the controller unit 80 and outputs intermediate frequency signals to the analog TV signal processing unit 60 (or the digital TV signal processing unit 70).

Then, in step ST22, the intensity of received signals is obtained on the basis of signals from the signal-intensity detection unit 109 (or 111) in the analog TV signal processing unit 60 (or the digital TV signal processing unit 70).

In step ST23, it is determined whether the signal intensity is equal to or more than a predetermined value. When it is determined that the signal intensity is equal to or more than the predetermined value, the process proceeds to step ST24. In step ST24, it is determined whether the received signals are TV signals. When it is determined that the received signals are TV signals, the process proceeds to step ST25.

In step ST25, the currently scanned frequency is registered in the scan frequency table 104 as a channel that can be received.

Then, in step ST26, the signal intensity obtained in step ST22 is registered for ones of the candidate frequencies to be scanned within a band with its center at the registered frequency.

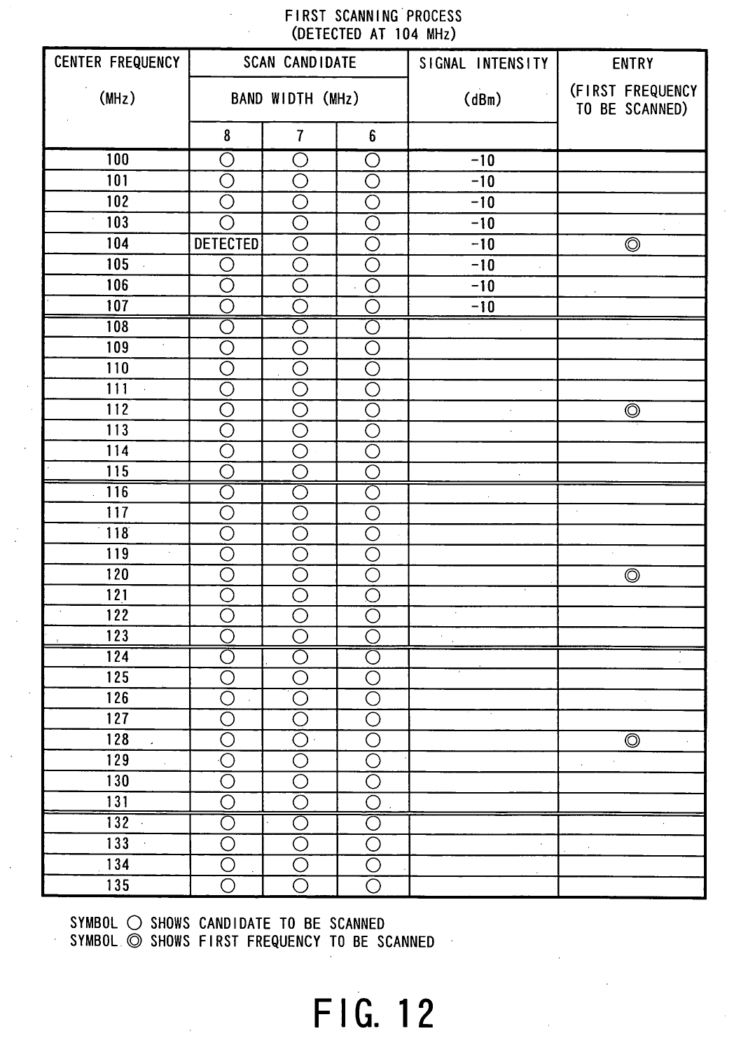

FIG. 12 shows the status of the scan frequency table 104 having been subjected to the forgoing process. Since TV signals are detected at a frequency of 104 MHz selected as one of the first frequencies to be scanned, and the width of the receive band is set to 8 MHz, “DETECTED” is set in a corresponding column to show the status.

Moreover, since the signal intensity obtained in step ST22 is −10 dBm, “−10” is set as the signal intensities of ones of the candidate frequencies to be scanned within a band with its center at the frequency of 104 MHz (ones of the candidate frequencies to be scanned in a range of 100 MHz to 107 MHz).

Then, in step ST27, ones of the candidate frequencies to be scanned in the neighborhood of the channel that can be received (the center frequency at which TV signals are detected) are eliminated from the scan frequency table 104.

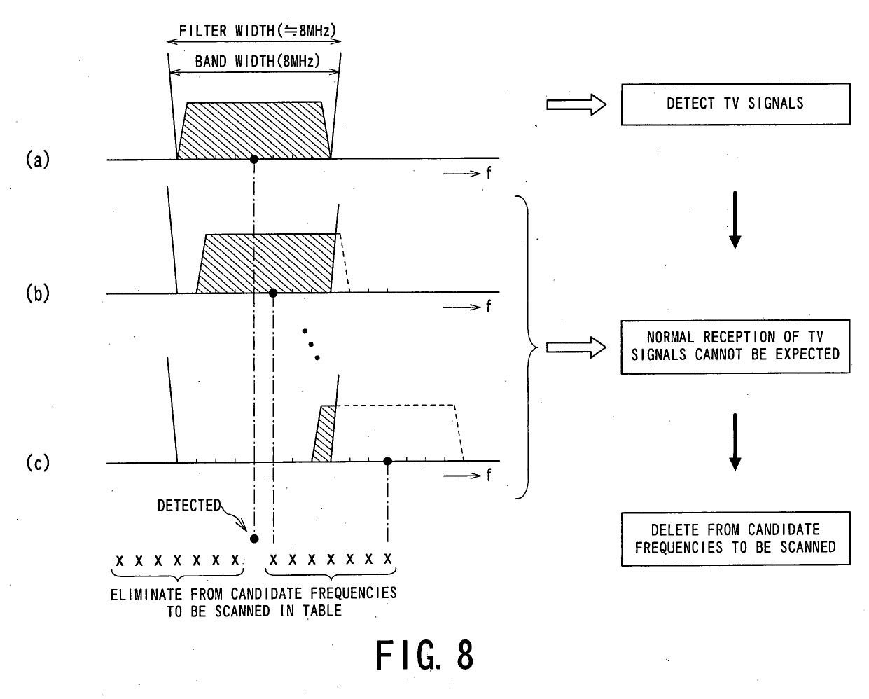

The reason will now be described with reference to FIG. 8. Part (a) of FIG. 8 shows a status in which TV signals are detected at one of the first frequencies to be scanned, for example, the frequency of 104 MHz. Having detected TV signals at the frequency of 104 MHz means that the band of the TV signals extends with its center at the frequency of 104 MHz. That is to say, this means that almost the entirety of the band of the TV signals falls within the band of the receive filter.

Thus, when TV signals that have a center frequency shifted from the frequency of 104 MHz exist, some components of the TV signals are removed by the receive filter. Parts (b) and (c) of FIG. 8 show this status. Thus, normal reception of TV signals that have a center frequency shifted from the frequency of 104 MHz cannot be expected.

It is meaningless to leave frequencies at which normal reception of TV signals cannot be expected in the scan frequency table 104 as the candidate frequencies to be scanned. Thus, ones of the candidate frequencies to be scanned in the neighborhood of the center frequency at which TV signals are detected are eliminated from the scan frequency table 104.

The center frequencies of bands that overlap a band with its center at the center frequency at which TV signals are detected are deleted from the candidate frequencies to be scanned.

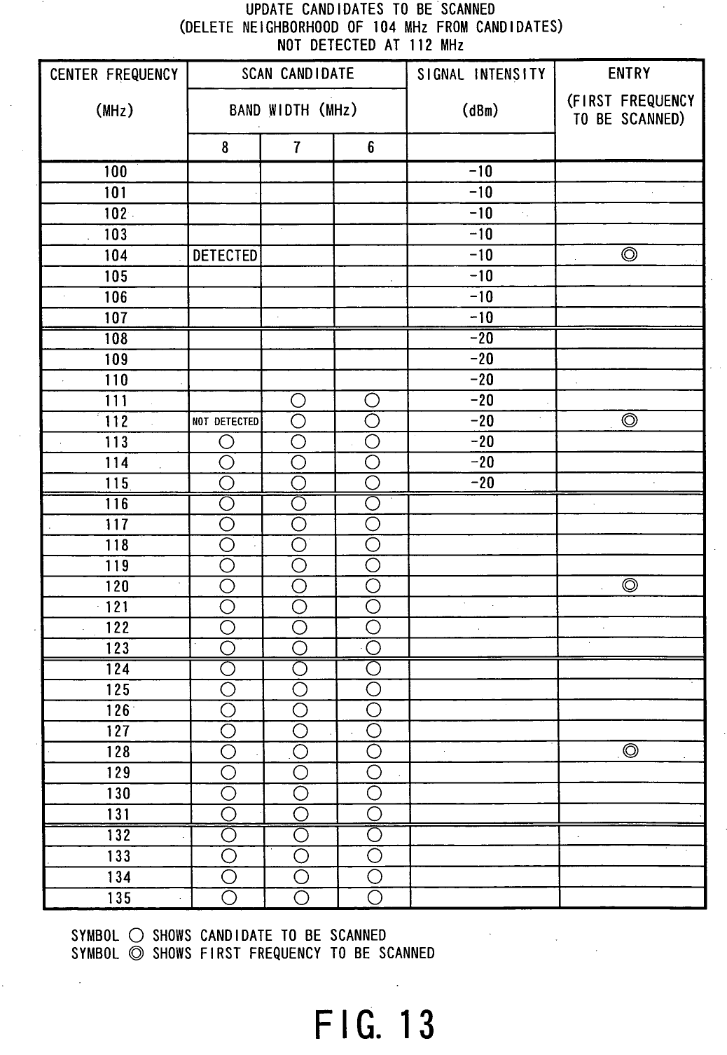

FIG. 13 shows the status of the scan frequency table 104 from which ones of the candidate frequencies to be scanned in the neighborhood of the frequency of 104 MHz are eliminated. In this case, in the frequency range shown in the drawing, regarding the 8-MHz band, ones of the candidate frequencies to be scanned in a range of 100 MHz to 103 MHz and a range of 105 MHz to 111 MHz are eliminated. Regarding the 7-MHz band and the 6-MHz band, ones of the candidate frequencies to be scanned in a range of 100 MHz to 103 MHz and a range of 105 MHz to 110 MHz are eliminated.

As for the frequency of 104 MHz, since TV signals are detected in the 8-MHz band, it is meaningless to leave entries for the 7-MHz band and the 6-MHz band corresponding to the same frequency of 104 MHz in the scan frequency table 104. Thus, these two entries are also deleted.

In step ST30, it is determined whether all of the first frequencies to be scanned have been scanned. When it is determined that all of the first frequencies to be scanned have not been scanned, the process goes back to step ST21, and the foregoing process is repeated.

On the other hand, for the one of the first frequencies to be scanned set in the tuner unit 50, when it is determined in step ST23 that the signal intensity is less the predetermined value or when it is determined in step ST24 that TV signals are not detected, it is determined that no TV signal exists at the one of the first frequencies to be scanned, and the one of the first frequencies to be scanned is eliminated from the scan frequency table 104 in step ST28.

However, in this case, in step ST29, the signal intensity obtained in step ST22 is registered for ones of the candidate frequencies to be scanned within a band with its center at the one of the first frequencies to be scanned.

In FIG. 13, a status is displayed as “NOT DETECTED”, in which no TV signal is detected at a second one (a center frequency of 112 MHz) of the first frequencies to be scanned. FIG. 13 also shows that a corresponding signal intensity is −20 dBm.

When no TV signal is detected at one of the first frequencies to be scanned in the first scanning process, for the one of the first frequencies to be scanned, not only regarding the 8-MHz band but also regarding the 7-MHz band and the 6-MHz band, corresponding entries are eliminated from the scan frequency table 104.

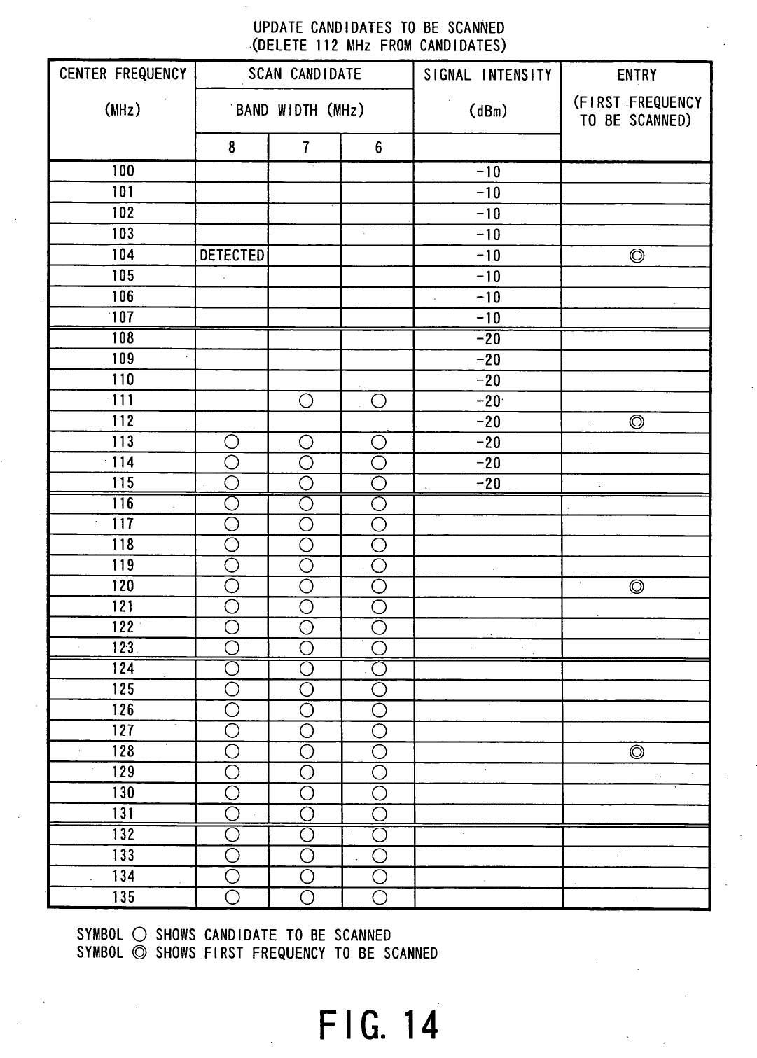

FIG. 14 shows the status of the scan frequency table 104 from which entries corresponding to the center frequency of 112 MHz are eliminated for the three types of band because no signal is detected at the center frequency of 112 MHz.

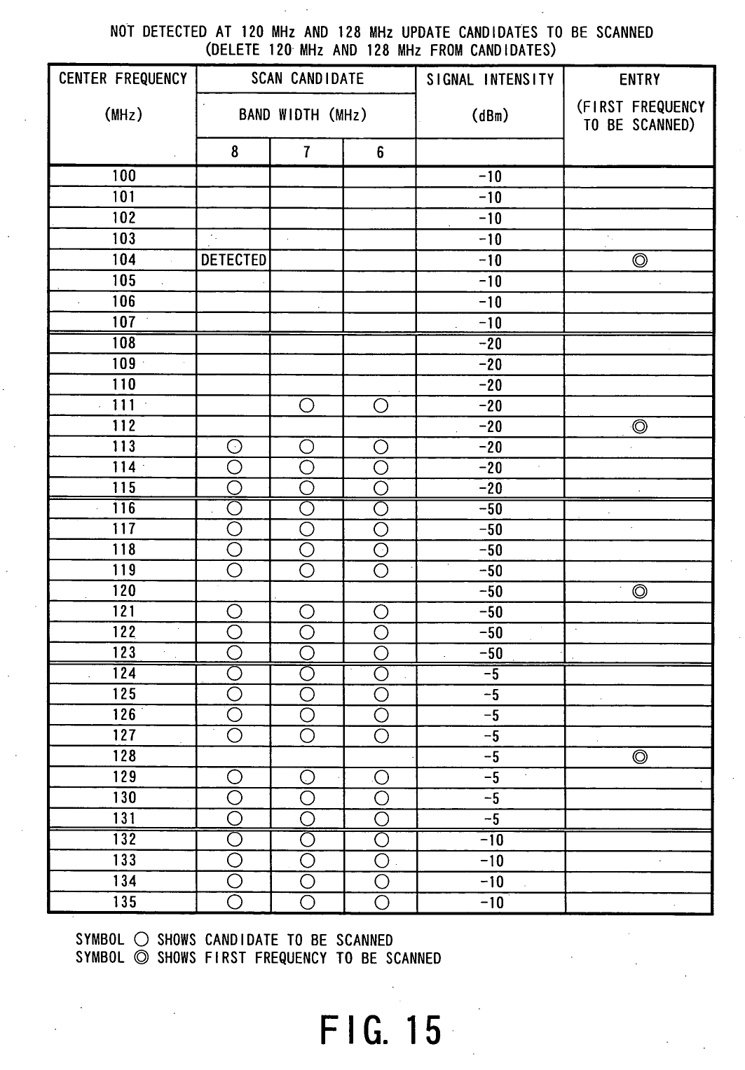

FIG. 15 shows the status of the scan frequency table 104 having been subjected to the first scanning process.

FIG. 15 shows that, in the shown frequency range, out of the first frequencies to be scanned, TV signals are detected only at the frequency of 104 MHz, and the signal intensity is less than the predetermined value or no TV signal is detected at frequencies of 112 MHz, 120 MHz, and 128 MHz.

When the first scanning process is completed in step ST2 in FIG. 5, in step ST3, scanning priorities in the second scanning process are determined on the basis of the signal intensities registered in the scan frequency table 104 in the first scanning process.

Specifically, the stronger a signal intensity obtained at a frequency, the higher a priority to be assigned to the frequency. Priorities are assigned to entries corresponding to the same frequency in descending order of band width, i.e., the 8-MHz band, the 7-MHz band, and the 6-MHz band.

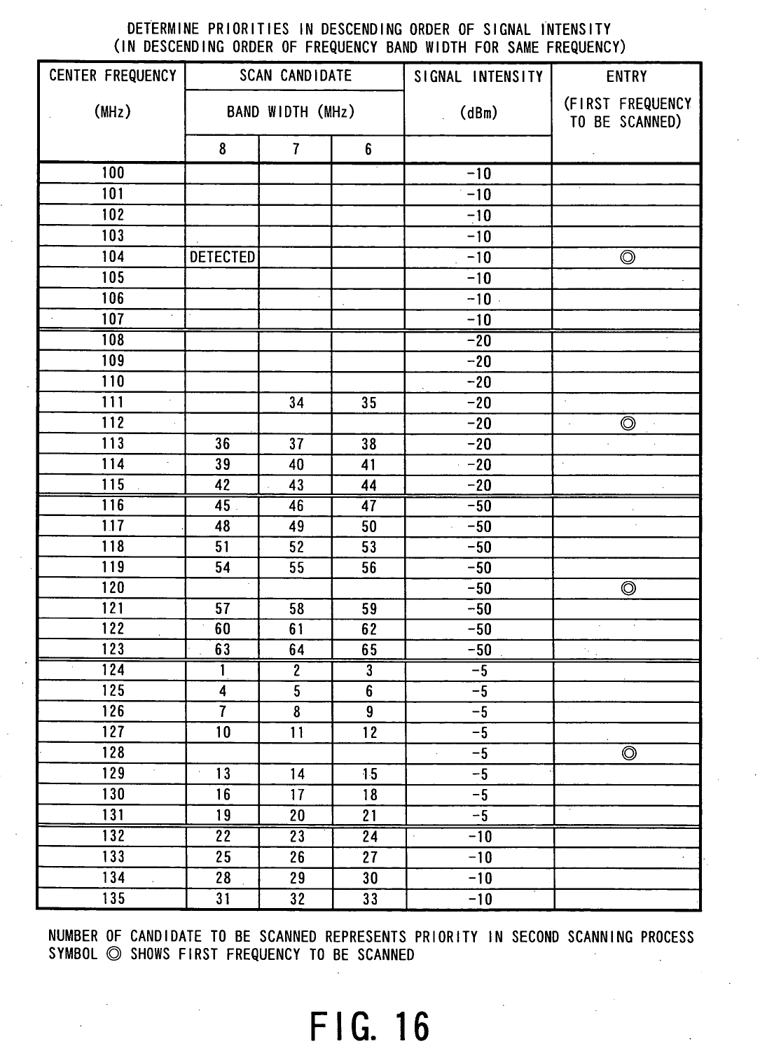

FIG. 16 shows exemplary assignment of priorities to entries in the column “SCAN CANDIDATE” in the scan frequency table 104. In FIG. 16, numbers each of which represents a priority are shown in the scan frequency table 104, instead of the symbols ◯ (shown in FIG. 15) corresponding to ones of the candidate frequencies to be scanned that remain when the first scanning process has been completed.

In this case, since the signal intensity of ones of the candidate frequencies to be scanned within a range of 124 MHz to 131 MHz is strongest, i.e., −5 dBm, priority numbers 1 to 21 are assigned to the range. The smaller the priority number, the higher the priority.

Similarly, priorities are assigned to remaining ones of the candidate frequencies to be scanned in descending order of signal intensity, i.e., −10 dBm, −20 dBm, and −50 dBm.

When priority assignment is completed, in step ST4 in FIG. 5, the second scanning process is performed according to the assigned priorities.

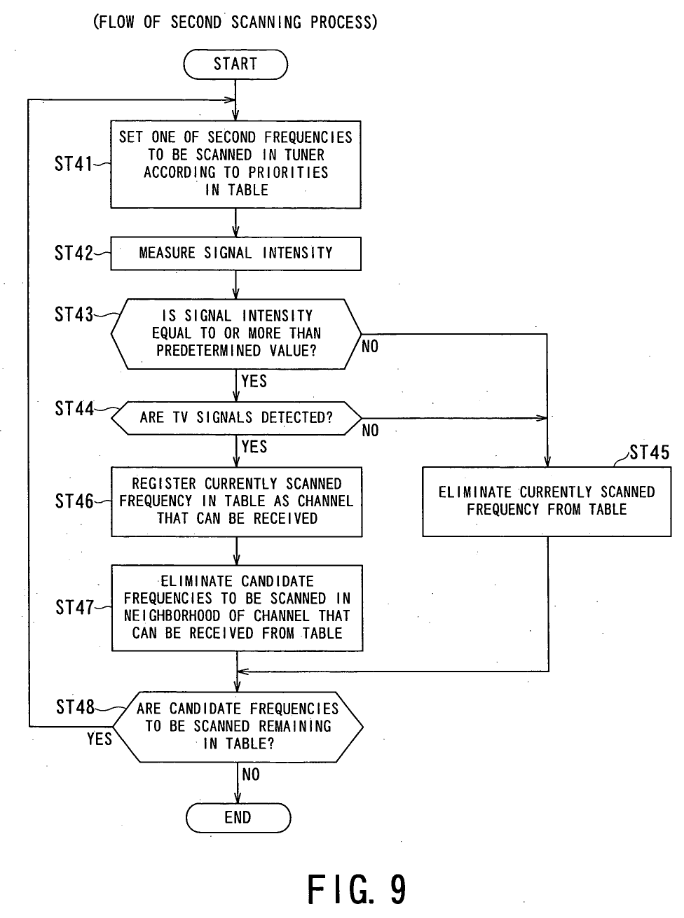

FIG. 9 shows a flowchart showing the details of the second scanning process. Remaining ones of the candidate frequencies to be scanned in the scan frequency table 104 having been subjected to the foregoing process are second frequencies to scanned.

In step ST41, one of the second frequencies to scanned is selected according to the priorities registered in the scan frequency table 104 and is set in the tuner unit 50.

In steps ST42 and ST43, a corresponding signal intensity is obtained, and it is determined whether the signal intensity is equal to or more than the predetermined value, as in the first scanning process.

Then, in step ST44, it is determined whether TV signals are detected at the one of the second frequencies to be scanned set in the tuner unit 50.

When it is determined that the signal intensity is less than the predetermined value or when it is determined that TV signals are not detected, the one of the second frequencies to be scanned is eliminated from the scan frequency table 104 in step ST45.

On the other hand, when TV signals are detected, the one of the second frequencies to be scanned is registered in the scan frequency table 104 as a channel that can be received in step ST46.

Then, in step ST47, ones of the candidate frequencies to be scanned in the neighborhood of the frequency, at which TV signals are detected, are eliminated from the scan frequency table 104, as in the first scanning process.

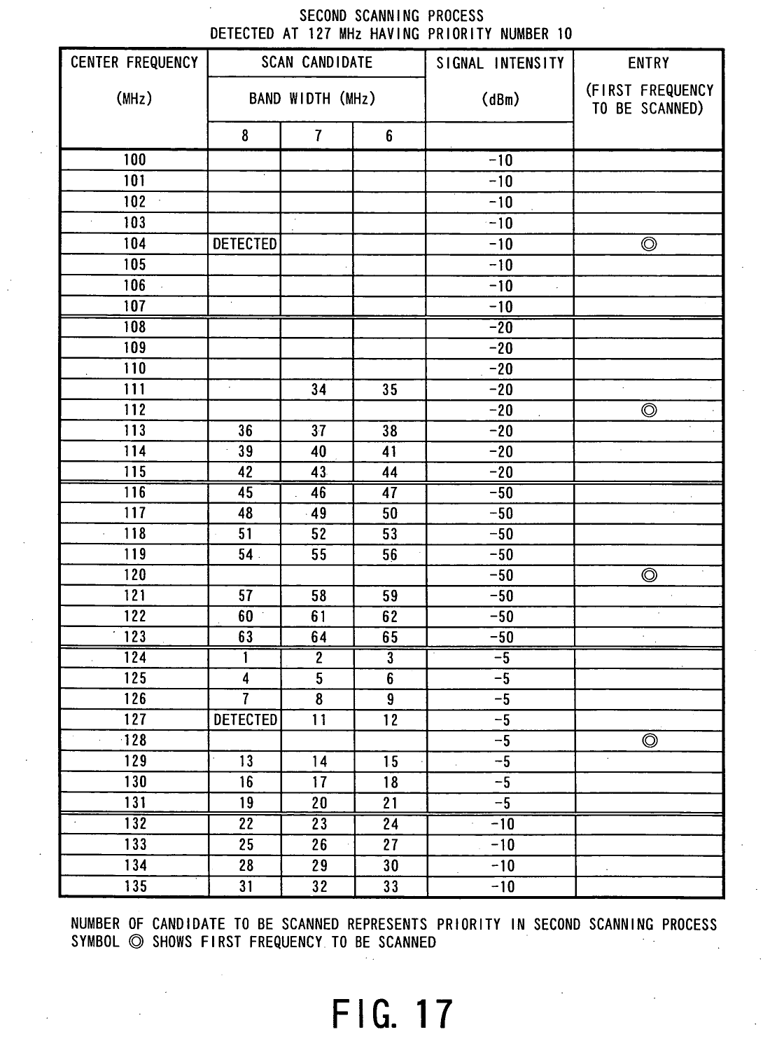

FIG. 17 shows that, when a center frequency of 127 MHz having a priority number 10 is set in the tuner unit 50 in the second scanning process, TV signals are detected. As the result, ones of the candidate frequencies to be scanned in the neighborhood of the center frequency of 127 MHz are eliminated from the scan frequency table 104.

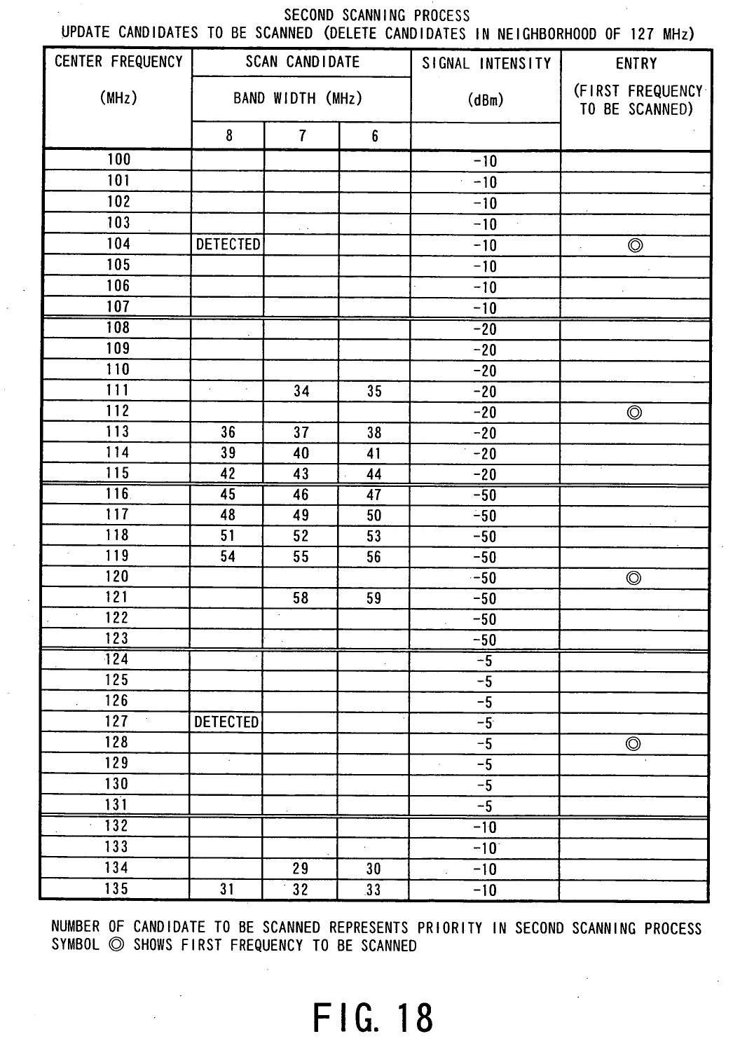

FIG. 18 shows the status of the scan frequency table 104 from which the ones of the candidate frequencies to be scanned in the neighborhood of the center frequency of 127 MHz are eliminated.

In this way, in the second scanning process, the candidate frequencies to be scanned are gradually eliminated, as in the first scanning process.

In step ST48, it is determined whether the remaining candidate frequencies to be scanned are completely eliminated from the scan frequency table 104. When it is determined that the remaining candidate frequencies to be scanned are not completely eliminated from the scan frequency table 104, the process goes back to step ST41, and the foregoing process is repeated. When it is determined that the remaining candidate frequencies to be scanned are completely eliminated from the scan frequency table 104, the second scanning process is completed.

Only center frequencies at which TV signals are detected are supposed to remain in the scan frequency table 104 when the second scanning process is completed.

Then, in step ST5 in FIG. 5, the channel-frequency correspondence table 200, which supports the current environment in which the information processing apparatus 1 including the TV tuner unit 10 is located, is created on the basis of the scan frequency table 104 having been subjected to the second scanning process.

In the embodiment, the candidate frequencies to be scanned are gradually eliminated in the step of detecting TV signals in each of the first scanning process and the second scanning process. Thus, the time necessary to scan the entire frequency range in this method is very short compared with that in a method for performing determination of whether TV signals are detected for all candidate frequencies to be scanned.

Moreover, since scanning priorities are determined in the second scanning process on the basis of the signal intensities obtained in the first scanning process, the second scanning process can be performed in descending order of probability of existence of TV signals. Thus, TV signals can be detected in an early stage of the second scanning process. As the result, candidate frequencies to be scanned in the neighborhood of a frequency at which TV signals are detected can be eliminated in the early stage. This also significantly contributes to reduction in the scanning time.

In the tuner unit, the information processing apparatus including the tuner unit, and the method for detecting receive channels according to the embodiment, even when a broad frequency range needs to be scanned in many steps because information of TV transmit frequencies is not available, the automatic frequency registration can be efficiently performed in a short time.

What is claimed is:

1. A tuner unit that scans a predetermined frequency range, detects channel signals that can be received, and registers frequencies of the channel signals, the tuner unit comprising:
a scan-candidate registration unit that registers frequencies in the predetermined frequency range at predetermined minimum detection spacings as candidate frequencies to be scanned;
a scan-frequency selection unit that selects frequencies to be scanned from the candidate frequencies to be scanned at spacings each of which is substantially the same as a band width of the channel signals;
a first scan unit that scans the predetermined frequency range on the basis of the frequencies to be scanned;
a reception determination unit that determines whether channel signals that are scanned on the basis of the frequencies to be scanned can be received;
a scan-candidate-frequency update unit that registers, as detected frequencies, frequencies of ones of the channel signals that are determined by the reception determination unit as being capable of being received and eliminates ones of the candidate frequencies to be scanned within a predetermined range with its center at each of the detected frequencies to update the candidate frequencies to be scanned; and
a second scan unit that performs scanning on the basis of the updated candidate frequencies to be scanned after the first scan unit scans the predetermined frequency range,
wherein, even when the second scan unit performs scanning, the scan-candidate-frequency update unit registers, as detected frequencies, frequencies of ones of the channel signals that are determined by the reception determination unit as being capable of being received and eliminates ones of the candidate frequencies to be scanned within a predetermined range with its center at each of the detected frequencies to update the candidate frequencies to be scanned.

2. The tuner unit according to claim 1, further comprising:
a signal-intensity registration unit that associates signal intensities of ones of the channel signals that are received when the first scan unit scans the predetermined frequency range with corresponding ones of the candidate frequencies to be scanned and registers the signal intensities,
wherein the second scan unit performs scanning in descending order of signal intensity.

3. The tuner unit according to claim 2, wherein, when a plurality of band widths of the channel signals exist, for each of the candidate frequencies to be scanned, determination of whether reception can be performed is made for the individual band widths in descending order of band width.

4. The tuner unit according to claim 1, wherein, when frequencies of channel signals that can be received are known, the first scan unit also scans the known frequencies.

5. An information processing apparatus comprising:
an information-processing-apparatus body that performs various types of information processing;
a tuner unit that scans a predetermined frequency range, detects channel signals that can be received, and registers frequencies of the channel signals; and
a display that displays various types of information and images received by the tuner unit,
wherein
the tuner unit includes:
a scan-candidate registration unit that registers frequencies in the predetermined frequency range at predetermined minimum detection spacings as candidate frequencies to be scanned;
a scan-frequency selection unit that selects frequencies to be scanned from the candidate frequencies to be scanned at spacings each of which is substantially the same as a band width of the channel signals;
a first scan unit that scans the predetermined frequency range on the basis of the frequencies to be scanned;
a reception determination unit that determines whether channel signals that are scanned on the basis of the frequencies to be scanned can be received;
a scan-candidate-frequency update unit that registers, as detected frequencies, frequencies of ones of the channel signals that are determined by the reception determination unit as being capable of being received and eliminates ones of the candidate frequencies to be scanned within a predetermined range with its center at each of the detected frequencies to update the candidate frequencies to be scanned; and
a second scan unit that performs scanning on the basis of the updated candidate frequencies to be scanned after the first scan unit scans the predetermined frequency range, and
even when the second scan unit performs scanning, the scan-candidate-frequency update unit registers, as detected frequencies, frequencies of ones of the channel signals that are determined by the reception determination unit as being capable of being received and eliminates ones of the candidate frequencies to be scanned within a predetermined range with its center at each of the detected frequencies to update the candidate frequencies to be scanned.

6. The information processing apparatus according to claim 5, further comprising:
a signal-intensity registration unit that associates signal intensities of ones of the channel signals that are received when the first scan unit scans the predetermined frequency range with corresponding ones of the candidate frequencies to be scanned and registers the signal intensities,
wherein the second scan unit performs scanning in descending order of signal intensity.

7. The information processing apparatus according to claim 6, wherein, when a plurality of band widths of the channel signals exist, for each of the candidate frequencies to be scanned, determination of whether reception can be performed is made for the individual band widths in descending order of band width.

8. The information processing apparatus according to claim 5, wherein, when frequencies of channel signals that can be received are known, the first scan unit also scans the known frequencies.

9. A receive-channel detecting method for scanning a predetermined frequency range, detecting channel signals that can be received, and registering frequencies of the channel signals, the method comprising:
a scan-candidate registration step of registering frequencies in the predetermined frequency range at predetermined minimum detection spacings as candidate frequencies to be scanned;
a scan-frequency selection step of selecting frequencies to be scanned from the candidate frequencies to be scanned at spacings each of which is substantially the same as a band width of the channel signals;
a first scan step of scanning the predetermined frequency range on the basis of the frequencies to be scanned;
a reception determination step of determining whether channel signals that are scanned on the basis of the frequencies to be scanned can be received;
a scan-candidate-frequency update step of registering, as detected frequencies, frequencies of ones of the channel signals that are determined as being capable of being received and eliminating ones of the candidate frequencies to be scanned within a predetermined range with its center at each of the detected frequencies to update the candidate frequencies to be scanned; and
a second scan step of performing scanning on the basis of the updated candidate frequencies to be scanned after the first scan step scans the predetermined frequency range,
wherein, even when the second scan step performs scanning, the scan-candidate-frequency update step registers, as detected frequencies, frequencies of ones of the channel signals that are determined as being capable of being received and eliminates ones of the candidate frequencies to be scanned within a predetermined range with its center at each of the detected frequencies to update the candidate frequencies to be scanned.

10. The method according to claim 9, further comprising:
a signal-intensity registration step of associating signal intensities of ones of the channel signals that are received when the first scan step scans the predetermined frequency range with corresponding ones of the candidate frequencies to be scanned and registering the signal intensities,
wherein the second scan step performs scanning in descending order of signal intensity.

11. The method according to claim 10, wherein, when a plurality of band widths of the channel signals exist, for each of the candidate frequencies to be scanned, determination of whether reception can be performed is made for the individual band widths in descending order of band width.

12. The method according to claim 9, wherein, when frequencies of channel signals that can be received are known, the first scan step also scans the known frequencies.
